(19) United States
(12) Patent Application Publication
(10) Pub. No.: US 2026/0094747 A1
(43) Pub. Date: Apr. 2, 2026

(54) MULTI-MATERIAL CORE

(71) Applicant: GM Global Technology Operations LLC, Detroit, MI (US)

(72) Inventors: Yilun Luo, Ann Arbor, MI (US); Saranraj Karuppuswami, Farmington Hills, MI (US); Minh-Khai Nguyen, Troy, MI (US); Renato Amorim Torres, Pontiac, MI (US); Song He, Troy, MI (US); Lei Hao, Troy, MI (US); Mazharul Chowdhury, Canton, MI (US)

(73) Assignee: GM Global Technology Operations LLC, Detroit, MI (US)

(21) Appl. No.: 18/899,010

(22) Filed: Sep. 27, 2024

(51) Int. Cl. H01F 3/14; B60L 50/60

(52) U.S. Cl. CPC H01F 3/14; B60L 50/60; B60L 2210/40; B60L 2270/147

(57) ABSTRACT

A multi-material choke for a vehicle includes a first end and a second end spaced from the first end, one or more first segments defining a perimeter that extends between the first end and the second end, and one or more second segments coupled to and arranged circumferentially with respect to the perimeter of the one or more first segments, the one or more first segments and the one or more second segments defining at least one opening that extends between the first end and the second end.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates generally to electric vehicles and, more particularly, to a choke for an electric vehicle.

Electrical chokes (i.e., inductors) are widely used in battery chargers, inverters, DC-DC converters, electromagnetic interference (EMI) filters, and more generally, power conversion systems (PCS) of electric vehicles. Chokes can be configured to provide resistance to alternating current (AC) while allowing direct current (DC) to freely pass by. Many existing systems are single material chokes that cannot address more than one form of interference (i.e., electrical, thermal, or mechanical, etc.). Shortcomings of existing systems are addressed by one or more aspects of the present disclosure.

### SUMMARY

In one configuration, a multi-material choke for a vehicle is provided and includes a first end and a second end spaced from the first end, one or more first segments defining a perimeter that extends between the first end and the second end, and one or more second segments coupled to and arranged circumferentially with respect to the perimeter of the one or more first segments, the one or more first segments and the one or more second segments defining at least one opening that extends between the first end and the second end.

The multi-material choke may include one or more of the following optional aspects. For example, the one or more first segments can include one or more different materials. The one or more second segments can include one or more different materials.

According to at least one aspect, the one or more first segments and the one or more second segments can include one or more nanocystalline materials.

According to another aspect, the one or more first segments each includes a slot. The one or more second segments can be arranged in the slot of the one or more first segments.

According to at least one example, the one or more second segments extend from the first end to the second end.

According to another example, the one or more second segments extend between the first end and the second end.

According to at least one aspect, the one or more first segments include a higher thermal conductivity than at least one of the one or more second segments.

According to another aspect, the one or more second segments include a higher permeability than at least one of the one or more second segments.

In another configuration, a multi-material choke for a vehicle is provided and includes a first end and a second end spaced from the first end, one or more first segments defining a perimeter that extends between the first end and the second end, and one or more second segments coupled to and arranged radially with respect to the perimeter of the one or more first segments, the one or more first segments and the one or more second segments defining at least one opening that extends between the first end and the second end.

The multi-material choke may include one or more of the following optional aspects. For example, the one or more first segments can include one or more different materials. The one or more second segments can include one or more different materials.

According to at least one aspect, the one or more first segments and the one or more second segments can include one or more nanocystalline materials.

According to another aspect, the one or more first segments can include a higher thermal conductivity than at least one of the one or more second segments.

According to at least one example, the one or more second segments can include a higher permeability than at least one of the one or more second segments.

In yet another configuration, a vehicle is provided and includes a vehicle body and a propulsion system coupled to the vehicle body. The propulsion system includes an inverter having an input and an output, a battery communicatively coupled to the input of the inverter, and a motor communicatively coupled to the output of the inverter. The vehicle further includes a multi-material choke arranged with respect to the propulsion system. The propulsion system includes a first end and a second end spaced from the first end, one or more first segments defining a perimeter that extends between the first end and the second end, and one or more second segments coupled to and arranged radially and circumferentially with respect to the perimeter of the one or more first segments, the one or more first segments and the one or more second segments defining at least one opening that extends between the first end and the second end.

The vehicle may include one or more of the following optional aspects. For example, the multi-material choke is arranged between the battery and the input of the inverter.

According to at least one aspect, the multi-material choke can be arranged between the output of the inverter and the motor.

According to another aspect, the multi-material choke can be arranged within the motor.

### BRIEF DESCRIPTION OF THE DRAWINGS

The drawings described herein are for illustrative purposes only of selected configurations and are not intended to limit the scope of the present disclosure.

FIG. 1 is a front perspective view of a vehicle including a propulsion system according to principles of the present disclosure;

FIG. 2A is a schematic circuit diagram of a first configuration of the propulsion system of FIG. 1 including a choke;

FIG. 2B is a schematic circuit diagram of a second configuration of the propulsion system of FIG. 1 including a choke;

FIG. 2C is a schematic circuit diagram of a third configuration of the propulsion system of FIG. 1 including a choke;

FIG. 3 is a configuration of a choke according to principles of the present disclosure;

FIG. 4 is another configuration of a choke according to principles of the present disclosure;

FIG. 5 is a graph showing frequency versus inductance for existing chokes and chokes according to principles of the present disclosure;

FIG. 6 is an end view of another configuration of a choke according to principles of the present disclosure;

FIG. 7 is an end view of another configuration of a choke according to principles of the present disclosure;

FIG. 8 is an end view of another configuration of a choke according to principles of the present disclosure;

FIG. 9 is an end view of another configuration of a choke according to principles of the present disclosure;

FIG. 10 is an end view of another configuration of a choke according to principles of the present disclosure;

FIG. 11 is an end view of another configuration of a choke according to principles of the present disclosure;

FIG. 12 is an end view of another configuration of a choke according to principles of the present disclosure;

FIG. 13 is an end view of another configuration of a choke according to principles of the present disclosure;

FIG. 14A is an end view of another configuration of a choke according to principles of the present disclosure;

FIG. 14B is an end view of one segment of the choke of FIG. 13A according to the principles of the present disclosure; and

FIG. 14C is an end view of another segment of the choke of FIG. 13A according to the principles of the present disclosure.

Corresponding reference numerals indicate corresponding parts throughout the drawings.

### DETAILED DESCRIPTION

Example configurations will now be described more fully with reference to the accompanying drawings. Example configurations are provided so that this disclosure will be thorough, and will fully convey the scope of the disclosure to those of ordinary skill in the art. Specific details are set forth such as examples of specific components, devices, and methods, to provide a thorough understanding of configurations of the present disclosure. It will be apparent to those of ordinary skill in the art that specific details need not be employed, that example configurations may be embodied in many different forms, and that the specific details and the example configurations should not be construed to limit the scope of the disclosure.

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising,” “including,” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

When an element or layer is referred to as being “on,” “engaged to,” “connected to,” “attached to,” or “coupled to” another element or layer, it may be directly on, engaged, connected, attached, or coupled to the other element or layer, or intervening elements or layers may be present. In contrast, when an element is referred to as being “directly on,” “directly engaged to,” “directly connected to,” “directly attached to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The terms “first,” “second,” “third,” etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first,” “second,” and other numerical terms do not imply a sequence or order unless clearly indicated by the context. Thus, a first element, component, region, layer or section discussed below could be termed a second element, component, region, layer or section without departing from the teachings of the example configurations.

In this application, including the definitions below, the term “module” may be replaced with the term “circuit.” The term “module” may refer to, be part of, or include an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor (shared, dedicated, or group) that executes code; memory (shared, dedicated, or group) that stores code executed by a processor; other suitable hardware components that provide the described functionality; or a combination of some or all of the above, such as in a system-on-chip.

The term “code,” as used above, may include software, firmware, and/or microcode, and may refer to programs, routines, functions, classes, and/or objects. The term “shared processor” encompasses a single processor that executes some or all code from multiple modules. The term “group processor” encompasses a processor that, in combination with additional processors, executes some or all code from one or more modules. The term “shared memory” encompasses a single memory that stores some or all code from multiple modules. The term “group memory” encompasses a memory that, in combination with additional memories, stores some or all code from one or more modules. The term “memory” may be a subset of the term “computer-readable medium.” The term “computer-readable medium” does not encompass transitory electrical and electromagnetic signals propagating through a medium, and may therefore be considered tangible and non-transitory memory. Non-limiting examples of a non-transitory memory include a tangible computer readable medium including a nonvolatile memory, magnetic storage, and optical storage.

The apparatuses and methods described in this application may be partially or fully implemented by one or more computer programs executed by one or more processors. The computer programs include processor-executable instructions that are stored on at least one non-transitory tangible computer readable medium. The computer programs may also include and/or rely on stored data.

A software application (i.e., a software resource) may refer to computer software that causes a computing device to perform a task. In some examples, a software application may be referred to as an “application,” an “app,” or a “program.” Example applications include, but are not limited to, system diagnostic applications, system management applications, system maintenance applications, word processing applications, spreadsheet applications, messaging applications, media streaming applications, social networking applications, and gaming applications.

The non-transitory memory may be physical devices used to store programs (e.g., sequences of instructions) or data (e.g., program state information) on a temporary or permanent basis for use by a computing device. The non-transitory memory may be volatile and/or non-volatile addressable semiconductor memory. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

In general, battery electric vehicles (BEVs), plug-in hybrid electric vehicles (PHEVs), hybrid electric vehicles (HEVs), and fuel cell electric vehicles (xEV) can be affected by electromagnetic interference (EMI). For instance, EMI can interfere with operation of vehicle electronics and/or violate regulations of EMI. EMI is a process by which electromagnetic energy is transmitted from one electric device to another via radiation and/or conducting paths. Some types of EMI include radiated EMI, common-mode EMI, and differential EMI.

Radiated EMI emission starts from an emitting source, propagates via a radiating path, until it reaches a susceptible receiver. Strength of radiated EMI may depend on the source and the device and the susceptible receiver.

Common-mode EMI can be electrically generated when a circuit with large voltage slew rate (i.e., dV/dt) has a significant parasitic capacitance to ground. In other words, common-mode EMI appears as an unwanted current measured on one or more conductors in parallel and a common reference ground.

Differential EMI can be a signal that appears on two lines of a closed loop, but current flow is in opposite directions. This generally appears in series with a desired signal.

Typically, existing chokes rely on costly materials to manage one or more types of EMI and/or to filter noise currents. According to principles of the present disclosure, a choke is provided for reducing cost, reducing weight, improving thermal conductivity, and/or improving inductance for a target frequency.

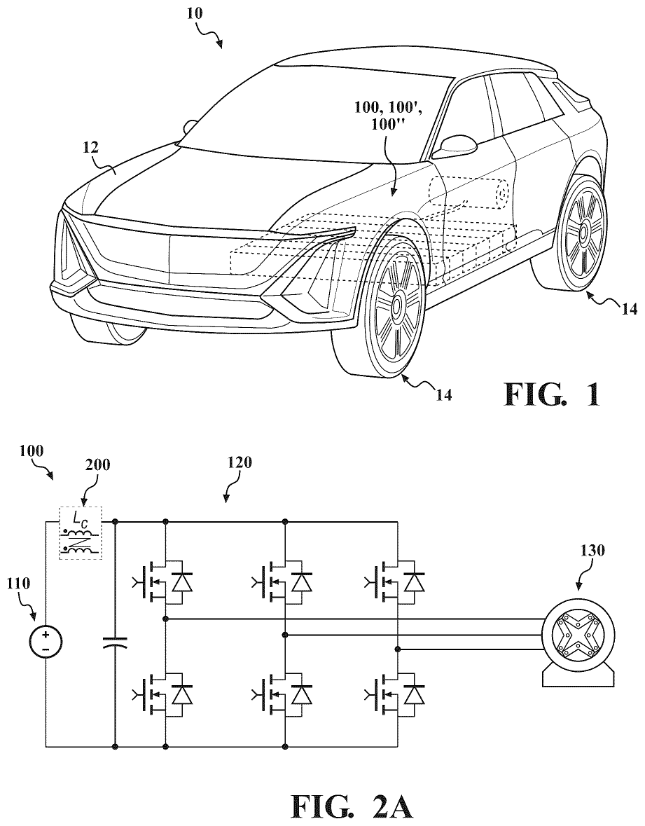

With reference to FIG. 1, an illustrative example of a vehicle 10 having a vehicle body 12 is provided. The vehicle 10 includes one or more wheels 14 coupled to the vehicle body 12. Additionally, the vehicle 10 includes a propulsion system 100 for providing power to at least one of the one or more wheels 14 to propel the vehicle 10.

In general, the propulsion system 100 includes a power source (e.g., a battery) 110, an inverter 120, and an electric motor (i.e., motor) 130. The inverter 120 includes an input coupled to the battery 110 and an output coupled to the motor 130.

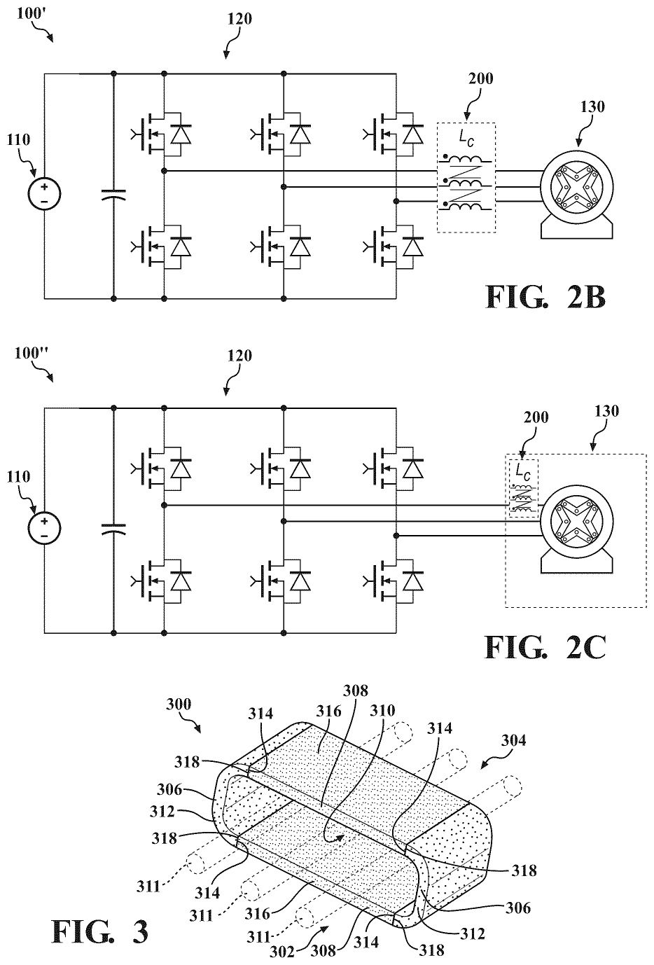

In one configuration, as shown in FIG. 2A, the propulsion system 100 also includes a choke 200 communicatively coupled to and arranged between the battery 110 and the input of the inverter 120. Arranging the choke 200 between the battery 110 and the inverter 120 may be desirable for reducing EMI emitted to or received from the other systems connected to the battery.

In another configuration, as shown in FIG. 2B, the propulsion system 100′ includes the choke 200 communicatively coupled to and arranged between the output of the inverter 120 and the motor 130. Arranging the choke 200 between the inverter 120 and the motor 130 may be desirable for reducing EMI, common mode current, and bearing current.

In yet another configuration, as shown in FIG. 2C, the propulsion system 100″ includes the choke 200 communicatively coupled to and arranged within the motor 130. Arranging the choke 200 within the motor 130 may be desirable for reducing the packaging size, overall weight, and increasing power density.

With reference to FIG. 3, a choke 300 is provided and includes two or more materials that are arranged circumferentially to enhance and/or target electrical, thermal, and/or mechanical properties. For instance, the choke 300 can be configured to filter noise currents, reduce electromagnetic interference, improve thermal conductivity, and/or reduce vibration. The choke 300 includes a first end 302 and a second end 304 spaced from the first end 302. The choke 300 includes one or more first segments 306 and one or more second segments 308 that are coupled to the first segments 306. The one or more first segments 306 and the one or more second segments 308 can be arranged to define a perimeter, such as a circumference, that extends between the first end 302 and the second end 304. Additionally, the one or more first segments 306 and the one or more second segments 308 can be arranged to define an opening 310 that extends between the first end 302 and the second end 304. The opening 310 can be configured to accommodate one or more wires or cables 311 extending between the first end 302 and the second end 304. In the present illustrative example, the one or more first segments 306 include end caps 312 that have one or more joint surfaces 314. The one or more second segments 308 can include plates 316 that have one or more end surfaces 318 that correspond with and are configured to be coupled with the one or more joint surfaces of the end caps 312.

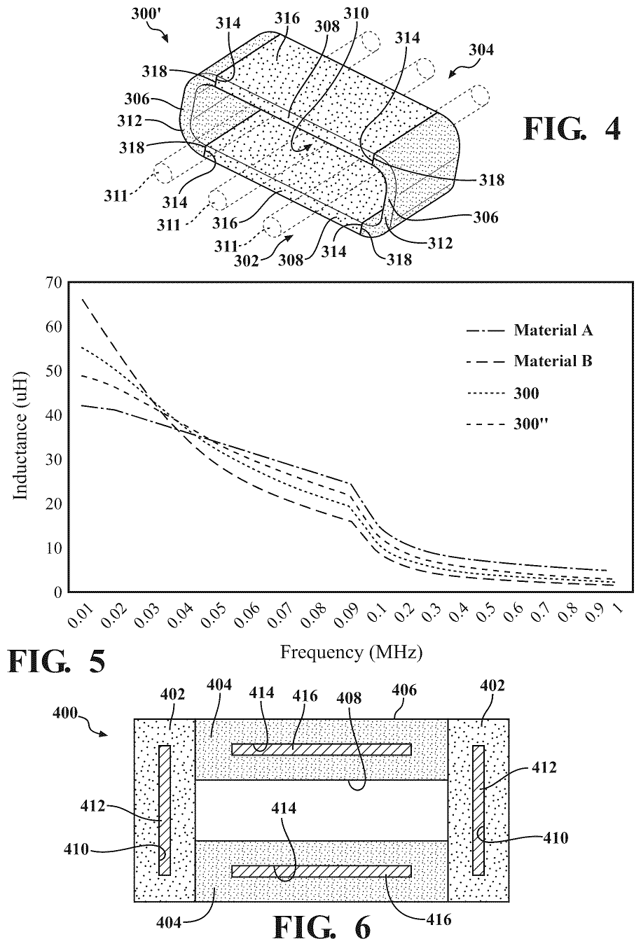

According to one aspect, the one or more first segments 306 can be made of a first material and the one or more second segments 308 can be made of a second material that is different from the first material. In at least one example, the first material and the second material are both nanocystalline materials, but include different electrical, thermal, and/or mechanical properties. In one configuration, as shown in FIG. 3, the one or more first segments 306 can be made of material A (e.g., FT-3K50T) and the one or more second segments 308 can be made of material B (e.g., FT-3KM). In another configuration, as shown in FIG. 4, the choke 300′ can be arranged so that the one or more first segments 306 are made of material B and the one or more second segments 308 are made of material A. Note, other materials can be selected for the one or more first segments 306 and/or the one or more second segments 308, such as other nanocystalline materials, ferrite material, magnetic material, thermally insulating materials, thermally conductive material, electrically insulating materials, or other materials commonly used for managing undesirable noise, filter frequency range, vibration, and/or harshness (NVH). Additionally or alternatively, a low magnetic permeability material can be arranged at a region of the choke 300 with a high electromagnetic field and a high permeability material can be arranged at a region of the choke 300 with a low electromagnetic field, or vice versa.

With reference to FIG. 5, a graph of frequency (MHz) versus inductance (μH) for two single material chokes and the chokes 300, 300′ made of more than one material are provided. The choke 300 achieved inductance similar to that of a single material choke made of material A in the low frequency range, beneficial to reduce bearing current, while lower inductance in the medium and high frequency range, beneficial to reduce choke loss. Notably, the choke 300′ replaced 40% of the total volume with material B that has a lower cost than material A.

FIG. 6 illustrates another illustrative configuration of a choke 400. This configuration is similar in many respects to the configuration of FIGS. 3-5. Accordingly, the descriptions of the configurations are hereby incorporated into one another, and description of subject matter common to the configurations generally may not be repeated.

With reference to FIG. 6, the choke 400 is provided and includes two or more materials that are arranged circumferentially to enhance and/or target electrical, thermal, and/or mechanical properties. For instance, the choke 400 can be configured to filter noise currents, reduce electromagnetic interference, improve thermal conductivity, and/or reduce vibration. The choke 400 includes one or more first segments 402 and one or more second segments 404 that are coupled to the first segments 402. The one or more first segments 402 can be coupled to or otherwise attached to the one or more second segments 404 via welding (e.g., spot, laser, etc.), brazing, adhesive, or another technique commonly used in the automotive industry. The one or more first segments 402 and the one or more second segments 404 can be arranged to define a perimeter 406. In the present example, the perimeter 406 is rectangular in shape, but other examples may include a circular, square, oval, or another shape for the perimeter 406. Additionally, the one or more first segments 402 and the one or more second segments 404 can be arranged to define an opening 408 that is configured to accommodate one or more wires or cables (not shown).

According to one aspect, the one or more first segments 402 can include a slot 410 that is configured to receive an insert 412. Likewise, the one or more second segments 404 can include a slot 414 that is configured to receive an insert 416. The one or more first segments can be made of a first material, the one or more second segments can be made of a second material, and the inserts 412, 416 can be made of a third material. According to one aspect, the inserts 412 for the one or more first segments 402 can be made of the third material and the inserts 416 for the one or more second segments 404 can be made of a fourth material that is different from the third material. The inserts 412, 416 can be desirable for improving thermal management (e.g., heat dissipation) of the choke 400. For instance, a material that includes a low thermal resistance (R) can be selected for the inserts 412, 416 that are located in regions of the choke 400 that comprise high thermal loss, for example.

The inserts 412, 416 can be arranged in the slots 410, 414, respectively, so that there are no air gaps between the inserts 412, 416 and the one or more first and second segments 402, 404. The lack of an air gap may be desirable to increase the inductance of the choke 400, for example. In another example, one of the inserts 412, 416 may be arranged with respect to the one or more first and second segments 402, 404 so that there are air gaps (not shown). Including the air gap may be desirable to increase a saturation limit in a region of the choke 400, for example. According to one aspect, more than one of the chokes 400 can be stacked, attached, coupled, and/or arranged adjacent to each other so that there are multiple openings for multiple wires and/or cables, for example.

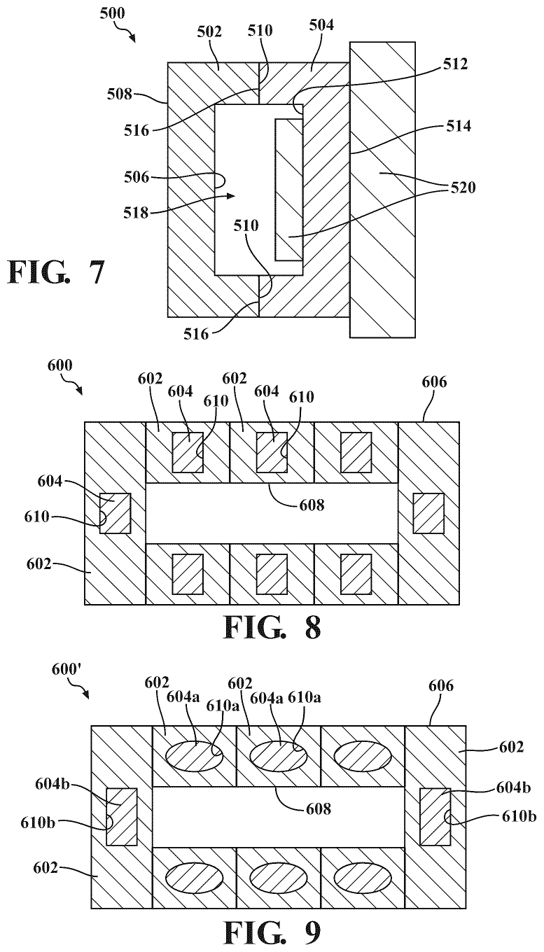

FIG. 7 illustrates another illustrative configuration of a choke 500. This configuration is similar in many respects to the configuration of FIGS. 3-5 and FIG. 6. Accordingly, the descriptions of the configurations are hereby incorporated into one another, and description of subject matter common to the configurations generally may not be repeated.

With reference to FIG. 7, the choke 500 includes a first segment or half 502 and a second segment or half 504. The first half 502 can generally include an inner surface 506 and an outer surface 508 spaced from the inner surface 506. The first half 502 can also include end surfaces 510 that extend between the inner surface 506 and the outer surface 508. The second half 504 can generally include an inner surface 512 and an outer surface 514 spaced from the inner surface 512. The second half 504 can also include end surfaces 516 that extend between the inner surface 512 and the outer surface 514. In the present illustrative example, the end surfaces 510, 516 of the first and second halves 502, 504 are configured to engage with one another so that an opening 518 is defined by the inner surface 506 of the first half 502 and the inner surface 512 of the second half 504. While not readily shown in FIG. 7, the choke 500 can include a hinge so that the first half 502 can open and close with respect to the second half 504 (i.e., a clam shell design).

According to one aspect, the first half 502 can be made of a first material and the second half 504 can be made of a second material that is different than the first material. For instance, the first half 502 can include a material that has superior thermal conductivity properties. Thus, according to at least one example, a cooling plate or casing 520 can be arranged on a portion of the inner and/or outer surfaces 512, 514 to remove heat from the second half 504 during operation, for example.

FIGS. 8-10 introduce illustrative configurations of a choke 600, 600′. These configurations are similar in many respects to the configurations of FIGS. 3-5, FIG. 6, and FIG. 7. Accordingly, the descriptions of the configurations are hereby incorporated into one another, and description of subject matter common to the configurations generally may not be repeated.

With reference to FIG. 8, the choke 600 is provided and includes one or more first segments 602 and one or more second segments 604. The one or more first segments 602 can be arranged to define a perimeter 606. Additionally, the one or more first segments 602 can be arranged to define an opening 608 that is spaced radially inwardly from the perimeter 606. Each of the one or more first segments 602 includes a through hole 610 that extends between a first end 612 and a second end (not shown) that extends into the page. As shown in FIG. 8, the one or more second segments 604 are arranged in the through holes 610. In the present illustrative example, the through holes 610 are rectangular and the second segments 604 are also rectangular. In another configuration, the through holes 610 and the second segments 604 are oval or triangular. In another configuration of the choke 600′, as shown in FIG. 9, some of the through holes 610 include a first shape 610a (e.g., oval-shaped) and a second shape 610b (e.g., rectangular). Accordingly, some of the one or more second segments 604 can be a first shape 604a (e.g. oval-shaped) and are configured to correspond with the through holes 610 that have the first shape 610a. Likewise, some of the one or more second segments 604 can be a second shape 604b (e.g., rectangular) and are configured to correspond with the through holes 610 that have the second shape 610b. According to one aspect, more than one of the chokes 600, 600′ can be stacked, attached, coupled, and/or arranged adjacent to each other so that there are multiple openings for multiple wires and/or cables, for example.

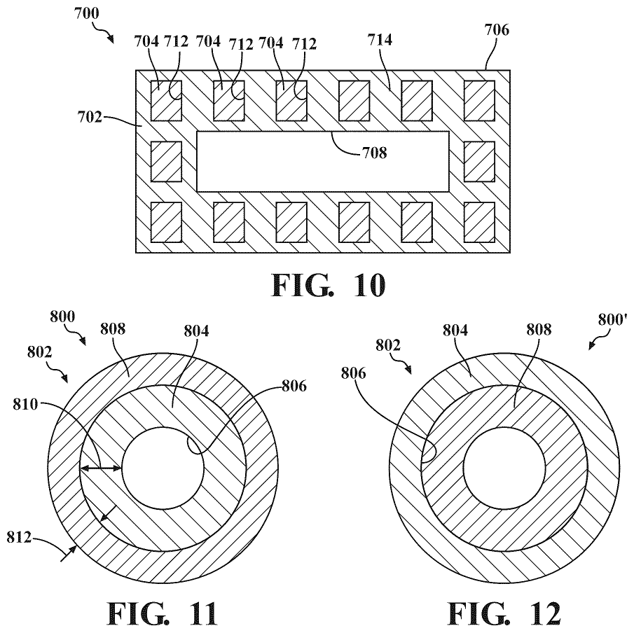

FIG. 10 illustrates an illustrative configuration of a choke 700. These configurations are similar in many respects to the configurations of FIGS. 3-5, FIG. 6, FIG. 7, and FIGS. 8-9. Accordingly, the descriptions of the configurations are hereby incorporated into one another, and description of subject matter common to the configurations generally may not be repeated.

With reference to FIG. 10, a unit cell of the choke 700 is provided. The choke 700 includes a first segment 702 and one or more second segments 704. The first segment 702 includes a perimeter 706 and an opening 708 that is spaced radially inwardly from the perimeter 706. The first segment 702 includes one or more through holes 712 that each extend between a first end 714 and a second end (not shown) that extends into the page. As shown in FIG. 10, the one or more second segments 704 are arranged in the through holes 712. The first segment 702 can be made of one or more different materials and the one or more second segments can be made of one or more different materials. According to one aspect, more than one of the chokes 700 can be stacked, attached, coupled, and/or arranged adjacent to each other so that there are multiple openings for multiple wires and/or cables, for example.

FIGS. 11-12 introduces illustrative configurations of a choke 800, 800′. These configurations are similar in many respects to the configurations of FIGS. 3-5, FIG. 6, FIG. 7, FIGS. 8-9, and FIG. 10. Accordingly, the descriptions of the configurations are hereby incorporated into one another, and description of subject matter common to the configurations generally may not be repeated.

With reference to FIG. 11, a choke 800 is provided and includes a first end 802 and a second end (not shown) that extends into the page and is spaced from the first end 802. The choke 800 includes a first segment 804 that includes an opening 806 and extends between the first end 802 and the second end (not shown). The choke 800 further includes a second segment 808 that is arranged radially with respect to the one or more first segments 804. The first segment 804 can have a first thickness 810 and the second segment 808 can have a second thickness 812. As shown in FIG. 11, the second segment 808 can be arranged radially outward of the first segment 804. In another instance, as shown in FIG. 12, the second segment 808 can be arranged radially inward of the first segment 804. According to one aspect, the second segment 808 can be overmolded onto the first segment 804. According to another aspect, the second segment 808 includes a sheet that can be wrapped around the first segment 804. According to yet another aspect, the first segment 804 can be molded inside of the second segment 808. Other manufacturing techniques may be used to arrange the first segment 804 with respect to the second segment 808. The first segment 804 can be made of a first material and the second segment 808 can be made of a second material that is different than the first material. According to at least one aspect, the chokes 800, 800′ include additional segments arranged radially with respect to the first segment 804 and second segments 808.

Note, the principles of the present disclosure and of the configurations of FIGS. 11 and 12 equally apply to chokes of different shapes. For instance, the first segment 804 and the second segment 808 can both be shaped like a triangle, rectangle, oval, or another shape. According to one aspect, the chokes 800, 800′ can be stacked, attached, coupled, and/or arranged adjacent one another so that there are multiple openings for multiple wires and/or cables, for example.

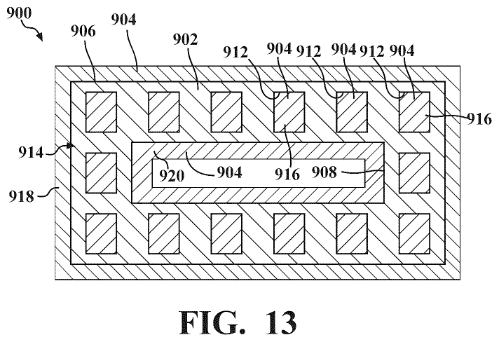

FIG. 13 illustrates another illustrative configuration of a choke 900. This configuration is similar in many respects to the configurations of FIGS. 3-5, FIG. 6, FIG. 7, FIGS. 8-9, FIG. 10, and FIGS. 11-12. Accordingly, the descriptions of the configurations are hereby incorporated into one another, and description of subject matter common to the configurations generally may not be repeated.

With reference to FIG. 13, the choke 900 includes one or more first segments 902 and one or more second segments 904. The one or more first segments 902 includes a perimeter 906 and an opening 908 that is spaced radially inwardly from the perimeter 906. The one or more first segments 902 can include one or more through holes 912 that each extend between a first end 914 of the choke 900 and a second end (not shown) opposite the first end 914. The one or more through holes are arranged circumferentially with respect to the perimeter 906. The one or more second segments 904 can include one or more inserts 916 arranged in the through holes 912. In other words, the one or more inserts 916 are arranged circumferentially in the one or more first segments 902 with respect to the perimeter 906. The one or more second segments 904 can also include one or more layers arranged radially with respect to the perimeter 906, for example. A first layer 918 can attached to the perimeter 906 of the one or more first segments 902. For instance, the first layer 918 can be overmolded or wrapped around the one or more first segments 902. A second layer 920 can be inserted into or molded into the opening 908 of the one or more first segments 902. The one or more first segments 902 can be made of one or more different materials and the one or more second segments 904 can be made of one or more different materials. According to one aspect, more than one of the choke 900 can be stacked, attached, coupled, and/or arranged adjacent to each other so that there are multiple openings for multiple wires and/or cables, for example.

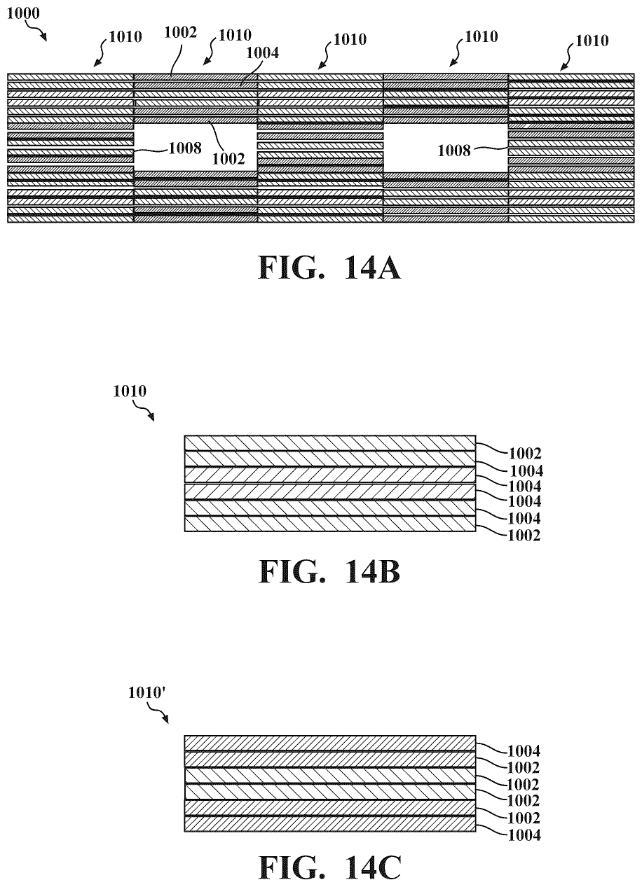

FIGS. 14A-14C illustrates another illustrative configuration of a choke 1000. This configuration is similar in many respects to the configurations of FIGS. 3-5, FIG. 6, FIG. 7, FIGS. 8-9, FIG. 10, FIGS. 11-12, and FIG. 13. Accordingly, the descriptions of the configurations are hereby incorporated into one another, and description of subject matter common to the configurations generally may not be repeated.

With reference to FIG. 14A, the choke 1000 one or more first segments 1002 and one or more second segments 1004. The one or more first segments 1002 define a perimeter 1006 and at least one opening 1008 that is spaced radially inwardly from the perimeter 1006. The one or more second segments 1004 define can define the perimeter 1006 and the at least one opening 1008. The choke 1000 includes one or more unit cells 1010 that each include the one or more first segments 1002 and/or the one or more second segments 1004. In at least one configuration, with reference to FIG. 14B, the unit cells 1010 can be arranged so that the one or more second segments 1004 are stacked between the one or more first segments 1002. In another configuration, with reference to FIG. 14C, the unit cells 1010′ can be arranged so that the one or more first segments 1002 are stacked between the one or more second segments 1004. Note, while not readily shown in the drawings, the choke 1000 can unit cells where the one or more first segments 1002 and the one or more second segments 1004 are stacked in an alternating fashion or in a non-patterned fashion. The one or more unit cells 1010 can be coupled to or otherwise attached to one another to define the perimeter 1006 and the at least one opening 1008, for example. According to at least one aspect, the one or more first segments 1002 can be made of one or more different materials and the one or more second segments 1004 can be made of one or more different materials. According to one aspect, more than one of the chokes 1000 can be stacked, attached, coupled, and/or arranged adjacent to each other so that there are multiple openings for multiple wires and/or cables, for example.

A number of implementations have been described. Nevertheless, it will be understood that various modifications may be made without departing from the spirit and scope of the disclosure. Accordingly, other implementations are within the scope of the following claims.

The foregoing description has been provided for purposes of illustration and description. It is not intended to be exhaustive or to limit the disclosure. Individual elements or features of a particular configuration are generally not limited to that particular configuration, but, where applicable, are interchangeable and can be used in a selected configuration, even if not specifically shown or described. The same may also be varied in many ways. Such variations are not to be regarded as a departure from the disclosure, and all such modifications are intended to be included within the scope of the disclosure.

What is claimed is:

1. A multi-material choke for a vehicle, comprising:
a first end and a second end spaced from the first end;
one or more first segments defining a perimeter that extends between the first end and the second end; and
one or more second segments coupled to and arranged circumferentially with respect to the perimeter of the one or more first segments, the one or more first segments and the one or more second segments defining at least one opening that extends between the first end and the second end.

2. The multi-material choke of claim 1, wherein the one or more first segments include one or more different materials.

3. The multi-material choke of claim 2, wherein the one or more second segments include one or more different materials.

4. The multi-material choke of claim 1, wherein the one or more first segments and the one or more second segments include one or more nanocystalline materials.

5. The multi-material choke of claim 1, wherein the one or more first segments each includes a slot.

6. The multi-material choke of claim 5, wherein the one or more second segments are arranged in the slot of the one or more first segments.

7. The multi-material choke of claim 6, wherein the one or more second segments extend from the first end to the second end.

8. The multi-material choke of claim 6, wherein the one or more second segments extend between the first end and the second end.

9. The multi-material choke of claim 1, wherein the one or more first segments include a higher thermal conductivity than at least one of the one or more second segments.

10. The multi-material choke of claim 1, wherein the one or more second segments include a higher permeability than at least one of the one or more second segments.

11. A multi-material choke for a vehicle, comprising:
a first end and a second end spaced from the first end;
one or more first segments defining a perimeter that extends between the first end and the second end; and
one or more second segments coupled to and arranged radially with respect to the perimeter of the one or more first segments, the one or more first segments and the one or more second segments defining at least one opening that extends between the first end and the second end.

12. The multi-material choke of claim 11, wherein the one or more first segments include one or more different materials.

13. The multi-material choke of claim 12, wherein the one or more second segments include one or more different materials.

14. The multi-material choke of claim 11, wherein the one or more first segments and the one or more second segments include one or more nanocystalline materials.

15. The multi-material choke of claim 11, wherein the one or more first segments include a higher thermal conductivity than at least one of the one or more second segments.

16. The multi-material choke of claim 11, wherein the one or more second segments include a higher permeability than at least one of the one or more second segments.

17. A vehicle, comprising:
a vehicle body;
a propulsion system coupled to the vehicle body, comprising:
an inverter having an input and an output,
a battery communicatively coupled to the input of the inverter, and
a motor communicatively coupled to the output of the inverter; and
a multi-material choke arranged with respect to the propulsion system, comprising:
a first end and a second end spaced from the first end,
one or more first segments defining a perimeter that extends between the first end and the second end; and
one or more second segments coupled to and arranged radially and circumferentially with respect to the perimeter of the one or more first segments, the one or more first segments and the one or more second segments defining at least one opening that extends between the first end and the second end.

18. The vehicle of claim 17, wherein the multi-material choke is arranged between the battery and the input of the inverter.

19. The vehicle of claim 17, wherein the multi-material choke is arranged between the output of the inverter and the motor.

20. The vehicle of claim 17, wherein the multi-material choke is arranged within the motor.
